(19) United States
(12) Patent Application Publication
(10) Pub. No.: US 2024/0068435 A1
(43) Pub. Date: Feb. 29, 2024

(54) System for electricity generation by capturing the energy of raising solar-heated air in suspended above the ground flexible multi-layered ducts

(71) Applicants: Benedict de St. Amatus, Forest Glen (AU); Alexander de St. Amatus, Forest Glen (AU)

(72) Inventors: Benedict de St. Amatus, Forest Glen (AU); Alexander de St. Amatus, Forest Glen (AU)

(21) Appl. No.: 18/233,334

(22) Filed: Aug. 14, 2023

Related U.S. Application Data
(60) Provisional application No. 63/400,418, filed on Aug. 24, 2022.

(51) Int. Cl. F03D 1/04; F24S 10/00; H02K 7/18

(52) U.S. Cl. CPC F03D 1/04; F24S 10/00; H02K 7/1823; F05B 2220/706

(57) ABSTRACT

This invention pertains to a system that generates electricity by capturing the energy of raising solar-heated air in suspended above the ground flexible multi-layered ducts. The system for electricity generation is provided with protection against damages caused by severe weather conditions, and its construction requires minimal ground preparation earthworks.

### CROSS-REFERENCE TO RELATED APPLICATIONS

U.S. Patent Application No. 63/400,418
U.S. Filing or 371(c) Date: Aug. 24, 2022
Application Type: Provisional

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention pertains to the field of renewable energy, and more particularly, to the field of conversion of solar energy to electricity.

### DESCRIPTION OF RELATED ART

The reference in this specification to any prior publication (or information derived from it), or to any matter which is known, is not, and should not be taken as an acknowledgment or admission or any form of suggestion, that the prior publication (or information derived from it) or known matter forms part of the common general knowledge in the field of endeavour, to which this specification relates.

One of the methods for electricity generation by capturing the energy of raising solar-heated air is in systems, which are historically known as solar updraft tower systems, also known as solar chimneys. The driving force in solar updraft tower systems is the radiation from the sun, which heats a solid body, most typically the earth, which then heats the air above. The hot air is less dense than the cold air and, as a result, it naturally moves in vertical direction. The solar updraft system confines and directs the moving hot air towards a turbine and a generator where its kinetic energy is converted to electricity.

An early description of a solar chimney power plant has been published by Gunther (1931). Patents on solar chimney's electric power generation have been granted between 1978 and 1981 in Australia (AU patent 499934B), Canada (CA patent 1023564), Israel (IL patent 50721) and the USA (U.S. Pat. No. 4,275,309). A number of research manuscripts on this topic have been published and several test facilities have been built around the world.

A web publication of Schlaich et al. describes the classical design of a solar updraft tower system. The solar updraft tower of the design described by Schlaich et al. has three essential elements, namely, a solar air collector at the base of the solar updraft tower, a chimney (tower), and a wind turbine. The solar air collector is formed by a roof that is transparent or translucent to the solar radiation and the natural ground below the roof, with an opening at the periphery of the collector that connects the air under the roof with the atmosphere. There is a vertical tower in the middle of the roof with air inlets at its base. The joint between the roof and the tower base is airtight. The solar radiation heats the natural ground below the roof, which heats the air between the ground and the roof. As hot air is less dense than cold air it begins to rise towards the chimney. Suction from the tower then draws in more hot air from the collector, and cold air comes in from the outer perimeter, forming a continuous air flow from the outside of the collector to the chimney. The energy of the flow is harnessed by the use of a turbine at the chimney base, which runs a generator that outputs electricity. The energy stored in the ground allows the tower to work overnight, although at a decreased level.

U.S. Pat. No. 7,026,723 proposes using hills or mountain slopes to support cylindrically shaped chimneys of solar updraft tower systems. The material of the chimneys is concrete, plastic or polymeric materials, for example, kevlar, polyvinylchloride (PVC), polycarbonate, or similar materials. The collectors are located at the bases of the chimneys. The collectors have roofs that are made from glass, plastic or polymeric materials, for example, kevlar, PVC or the like. The created updraft flow of air drives a turbine or a set of turbines.

U.S. Pat. No. 8,823,197B2 discloses a structure built as a long diagonal circular or oval chimney on a slope of a mountain, which can permanently generate airflow for producing electricity. In the invention's primary embodiment a diagonal chimney is laid on the side of sloping terrain. Laying the chimney diagonally on existing terrain reduces the engineering cost of supporting an extremely high altitude vertical chimney. The chimney's bottom end is substantially lower in elevation than its top end. Limited and gentle bends in the chimney may be built as needed to reduce engineering costs on unfavourable terrain. The air pathways may be of solid construction, they may be air-inflated tubes, they may be tent-like fabric tubes supported at regular lengths by poles, towers, girders or other structures, or they may be some combination of these construction methods. In use, air or other gases are continually drawn into the chimney's bottom end. The chimney's top end has an opening to release air. In this embodiment, the chimney's roof absorbs solar radiation. This heats the incoming air. The warmed air rises up the chimney. In this embodiment, a wind turbine is turned by the chimney's draft to produce electricity.

In one embodiment of U.S. Pat. No. 8,823,197B2, a solar chimney roof has multiple layers to deal with multiple engineering needs. The outermost layer blocks ultraviolet rays and protects the inner layers from water leakage, pounding from hail, blowing branches and sparks from wildfires. Beneath the outermost layer, a positive pressure containment layer girded by cables holds the chimney roof in place against positive pressure. Beneath the pressure containment layer an insulation layer reduces heat losses. Beneath the insulation layer a fairing layer held in place by guide struts reduces air turbulence in the air mass moving up the chimney at a fairly high velocity.

In other embodiment of U.S. Pat. No. 8,823,197B2, the chimney gathers ground-effect preheated air from a wide circumference around the bottom of the tube.

In a further embodiment of U.S. Pat. No. 8,823,197B2, a trench in the ground with a black cover through which inlet holes have been made at intervals, sucks down pre-warmed open desert surface air. In this embodiment the area directly on either side of the trench has been sprayed with tar to further heat the air near the inlet holes, and to heat the soil or sand around the trench so that the heated soil or sand in turn eventually heats the air inside the trench.

In a further embodiment of U.S. Pat. No. 8,823,197B2, a trench used to contain a stream of relatively unheated air has a substantially circular bottom half. This, plus a substantially circular top half cover maximizes the trench's cross-section for best airflow for its diameter. The trench's top half is a cover comprised of multiple air bladders, designed to be very long in the direction of air flow, which are kept inflated by one or more air pumps through one or more inflation tubes. The tubes form substantially a circular array of bulges around the trench/cover's hollow centre that is used for shipping warm or hot air. A low positive pressure within the central part of the trench created by an air current pushing fan will also help to keep the cover inflated against various outside pressures. The outside of the tube has flaps or other connectors so as to connect the tube to anchors in the ground. In the event of high winds, the air pumps deflate the bladder and a fan draws all air out of the trench's interior, and so the cover is held by vacuum flat against the trench's bottom.

In a further embodiment of U.S. Pat. No. 8,823,197B2, a section of an air tube has similar inflatable bladders around its entire circumference, top and bottom. In one embodiment, strong, resilient rings are installed around the air tube's outside to keep the air tube from bending shut in high winds.

In a further embodiment of U.S. Pat. No. 8,823,197B2, long rods extending lengthwise in an air stream enclosing tube holds fabric or plastic fairing surface fairly taut. The fairing may bulge in or out between the rods, based on whether the tube has negative or positive air pressure compared to air outside the fairing, but in the lengthwise direction the fairing has no bulges.

In a further embodiment of U.S. Pat. No. 8,823,197B2, numerous small air-gathering trenches are an economical way to supply a single, wide chimney with a stream of perpetual warm air. The sub-goal of building small trenches is to inexpensively transport somewhat moist, slightly warm air from distant spots, and to heat this air as the trench air approaches the next air heating stage. A long covering is attached to the tops of the walls, enclosing the trench. The trench covering may vary. A simple black fabric covering will transmit a small amount of heat into the enclosed air on sunny days. A clear or translucent single layer plastic or glass covering will transmit the sun's heat to the trench's bottom. In one embodiment a heat-absorbing trench is coated with a layer of a black or dark material on its bottom, for example, a spray of tar. Alternatively, a layer of tarpaper supported above the trench's bottom by an insulating layer will transfer a large percent of the absorbed solar heat into air heat, putting little of the heat into the ground below.

In a further embodiment of the U.S. Pat. No. 8,823,197B2, thin heat-conducting spikes are pounded into the bottoms of the trenches before they are covered, and radiator fins are then attached to the top ends of the spikes. In operation these spikes slowly transmit captured solar heat deep into the ground during the day, then draw the banked heat up at night for preheating air inside the trenches. The radiator fins are slanted parallel to the trench's direction, to allow roughly optimal airflow through the trench.

In a further embodiment of the U.S. Pat. No. 8,823,197B2, a progression of single glazed, then double-glazed, trench covers are used to cover a trench as the trench approaches a larger air collecting tube. The flow of air in the trench becomes hotter, and triple and more glazed cover becomes cost-effective to continue heating the air.

AU patent 2017100315 introduces the concept of solar-wind farms as a modification of the well known solar updraft tower systems in which the solar radiation heats a multi-layered material, the outer layer of which is transparent to the solar radiation and the inner layer of which absorbs the solar radiation and heats the surrounding air. There is sufficient distance between the ground, the inner layer and the outer layer to allow for free pass of the air. The multi-layered material is shaped in form of tubes, which tubes form the collectors of the solar wind farms. The collectors are laying on and anchored to the grounds on side of sloping terrains. The collectors are opened to the atmosphere at the ends. The heated air forms streams between the ground and the inner layer, and between the inner and outer layers of the collectors. The kinetic energy of the air streams is converted to electricity by suitably located turbines.

AU patent 2017101410 discloses a process and a system for recuperation of waste heat to co-generate electricity in solar-wind farms. In its typical configuration, a section of a solar-wind farm is assembled over a inclined ground. The bottom end of the solar-wind farm is connected to a source of waste heat. The collector of the solar-wind farm is exposed to the solar radiation. The heat from the sun adds energy to the air inside the collector, which is getting hotter and moves faster along the sections of the collector. The top end of the solar-wind farm is connected to a turbine that converts the energy of the moving hot air to electricity. The working fluid is constantly expelled from the top end of the solar-wind farm facility and replaced by new volumes of the working fluid carrying waste heat. In this invention, the electricity generated by the solar-wind farm can be supplemented by using more than one source of waste heat, for example, the waste heat from a landfill and waste heat from working apparatuses of different types. The electricity generation continues until there is an energy input from the solar radiation, and/or from the waste heat, and/or from heat stored in the ground on which the solar-wind farm is mounted and from the heat stored in the material from which the solar-wind farm is built, or/and from the heat stored in special heat storage pools.

To date, all types of systems that generate electricity by capturing the energy of the raising solar-heated air propose using structures of large size, both in horizontal and vertical directions. The large size of these systems necessitates using lightweight construction materials, which in turn makes these systems inevitably vulnerable to damages caused by such severe weather conditions as storms, strong wind, heavy rain, snow and hail, and also subjects them to increased wind loads. A second issue faced by the existing systems is the necessity of major earthworks to prepare the ground occupied by the systems.

### OBJECT OF THE INVENTION

It is an object of the present invention to overcome, or at least substantially ameliorate, the disadvantages and shortcomings of the prior art of generation of electricity in systems that generate electricity by capturing the energy of the raising solar-heated air.

In particular, the object of the present invention is to provide these systems with protection against damages caused by severe weather conditions.

Another object of the present invention is to minimise the risk of damages caused to the systems by high wind loads.

Yet another object of the present invention is to minimise the amount of ground preparation earthworks required for the construction of these systems.

Other objects and advantages of the present invention will become apparent from the following description, taken in connection with the accompanying drawings, wherein, by way of illustration and example, embodiments of the present invention are disclosed.

### SUMMARY OF THE INVENTION

According to one example of the present invention, the system for electricity generation by capturing the energy of raising solar-heated air comprises the following major parts:—

At least one flexible duct that has an airtight flexible wall, which wall has at least one part that is made from a flexible material that is transparent to the solar radiation.

An inner flexible membrane that is located inside said flexible duct and that is made from a flexible material that is highly absorptive to the solar radiation.

Two openings to the ambient atmospheric air at the ends of said flexible duct, one opening of said flexible duct being elevated above the other.

At least one tunnel within said flexible duct that is opened to the ambient atmospheric air at the openings of said flexible duct.

At least one air turbine that is coupled to at least one electric generator, and that is connected to at least one of the openings of said flexible duct.

Also, according to this example of the present invention, said flexible duct and said inner flexible membrane are radially stretched and supported in the air, above a ground of any nature and profile, by at least one carcass that comprises a plurality of tensioned cables. The cables that comprise the carcasses that support said flexible duct and said inner flexible membrane are auto-tensioned by sets of counterweights and/or by any hydraulic and/or electro-mechanic types of auto-tensioners, in order to maintain said cables evenly tensioned irrespectively of the changes of the ambient temperature.

A retracting, protracting and tensioning system comprising at least one winch and brake mechanism and pluralities of pulleys, springs. ballasts, connectors, anchors and cables, is used for retracting, protracting and tensioning said flexible duct and said inner flexible membrane in and out of the coverage of a weather protector, whenever it is required to provide protection to said flexible duct and said inner flexible membrane against damages caused by severe weather conditions and to minimise the risk of damages to said flexible duct and said inner flexible membrane caused by high wind loads. The weather protector of said flexible duct and said inner flexible membrane is made from a material that is capable of withstanding severe weather conditions and high wind loads. At least one tunnel inside said flexible duct provides an unobstructed passage of the atmospheric air between the openings of said flexible duct, when said flexible duct and said inner flexible membrane are tensioned by the retracting, protracting and tensioning system.

In use, said inner flexible membrane absorbs radiative energy from the sun and heats the surrounding air to a temperature that is above the temperature of the ambient atmospheric air, causing the surrounding air to raise and to flow upwardly inside the tunnels of said flexible duct, and causing the air turbine that is coupled to the electric generator to rotate and to convert the energy of the raising air flow to electricity.

Other features of this example of the present invention include but they are not limited to:—

The contact surface between said inner flexible membrane and the air is increased by corrugating and/or making said inner flexible membrane uneven by any other means, and/or by adding fins of any kind.

The energy of the raising solar-heated air is supplemented by the energy of raising air that is heated by other sources of heat and the supplemented heat is recuperated to electrical energy.

The energy losses of said electricity generation system are minimised by reflecting thermal radiation coming from the hot parts of said electricity generation system back to its inner flexible membranes.

The energy output of said electricity generation system is maximised by storing heat in thermal reservoirs during daytime and releasing the heat stored in the thermal reservoirs during night time to be converted to electricity in said electricity generation system.

The energy output of said electricity generation system is maximised by intensifying the process of heat transfer between the inner flexible membranes and the passing air streams by spraying and/or pouring water over said inner flexible membranes where the water evaporates and the heat of the vapour supplements the energy of the passing air streams.

A positioning mechanism is used to move and/or rotate the flexible duct in order to maximise the exposure of the inner flexible membrane to the solar radiation and to increase energy output of said electricity generation system.

### BRIEF DESCRIPTION OF THE DRAWING

By way of illustration only, an embodiment of the invention is described more fully hereinafter with reference to the accompanying drawings, in which:—

FIG. 1 is a side view of an embodiment of a system for electricity generation by capturing the energy of raising solar-heated air in an inclined, flexible, multilayered duct that is suspended lengthwise on a carcass that comprises a plurality of tensioned flexible cables in the air above a flat, horizontal ground.

FIG. 2 is a top view of the embodiment of the system for electricity generation that is shown in FIG. 1.

FIG. 3 is an example of the cross-section of the inclined, flexible, multilayered duct of the system for electricity generation of the type shown in FIGS. 1, 2.

FIG. 4 is an example of one of the connecting and tensioning units that connects and radially tensions a suspended on the tensioned cables rigid rib to the lengthwise sealed edges of the membranes of the inclined, flexible, multilayered duct of the system for electricity generation of the type shown in FIGS. 1, 2.

FIG. 5 is a side view of the embodiment of the system for electricity generation by capturing the energy of raising solar-heated air in the inclined, flexible, multilayered duct that is suspended lengthwise in the air above an inclined ground.

FIG. 6 is a view of the embodiment of the system for electricity generation by capturing the energy of raising solar-heated air in the flexible, multilayered duct, in which said duct is suspended along a vertical wall of a building.

FIG. 7 is a view of the embodiment of the system for electricity generation by capturing the energy of raising solar-heated air in the inclined, flexible, multilayered duct, in which said electricity generation system is supported by trees.

FIG. 8 is a side view of an embodiment of a system for electricity generation by capturing the energy of raising solar-heated air in flexible ducts that are supported and radially stretched by upstanding carcasses comprising meshes of tensioned flexible cables.

FIG. 9 is a side view of an example of the mesh arrangement of the cables comprising the upstanding outer flexible carcass of the system for electricity generation of the type shown in FIG. 8.

FIG. 10 is an example of the system for electricity generation of the type shown in FIG. 8, in which said electricity generation system is suspended in the air by a bamboo scaffold.

FIG. 11 is an example of the system for electricity generation of the type shown in FIG. 8, in which two units of said electricity generation system are suspended in the air on a single tree.

FIG. 12 is a cross-section near the air outlets of the system for electricity generation of the type shown in FIG. 8, in which a single pole is inserted inside the carcasses and supports the weight of said carcasses and the electricity generation unit.

### DETAILED DESCRIPTION OF THE INVENTION

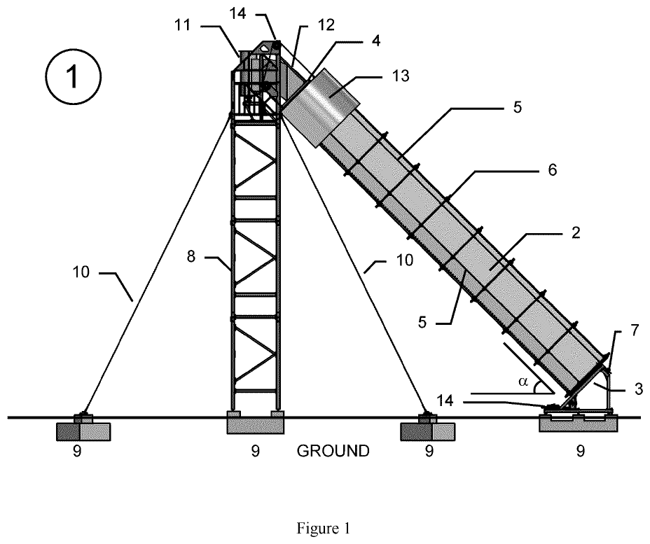

Embodiments of systems for electricity generation by capturing the energy of raising solar-heated air in suspended above the ground, inclined, multi-layered, flexible ducts and in flexible ducts that are supported by upstanding flexible carcasses, according to the present invention, are shown with references to FIGS. 1 to 12.

Accordingly, it is to be understood that the embodiments of the invention herein described are merely illustrative of the application of the principles of the invention. References herein to details of the illustrated embodiments are not intended to limit the scope of the claims, which themselves recite those features regarded as essential to the invention.

FIG. 1 shows a side view of an embodiment of a system for electricity generation by capturing the energy of raising solar-heated air 1, comprising an inclined, flexible, multilayered duct 2 that is suspended lengthwise in the air above a ground that may be of any nature and profile, but in this particular example is a flat, horizontal ground.

The inclined, flexible, multilayered duct 2 has openings to the ambient atmosphere only at its opposite ends through an air inlet 3 and an air outlet 4, wherein the air outlet 4 is located above the air inlet 3.

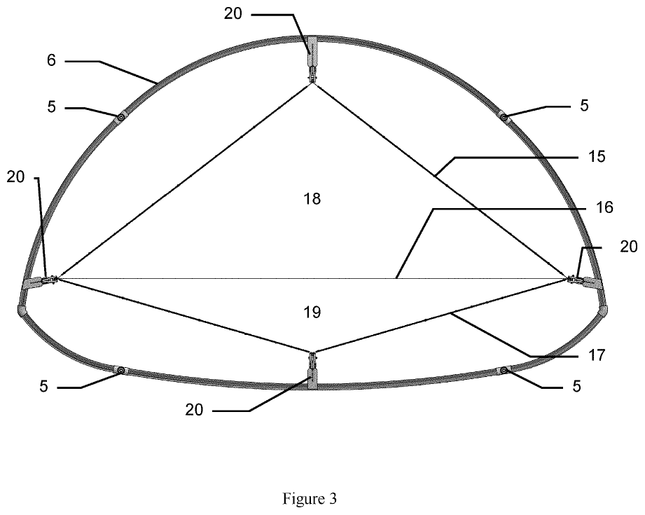

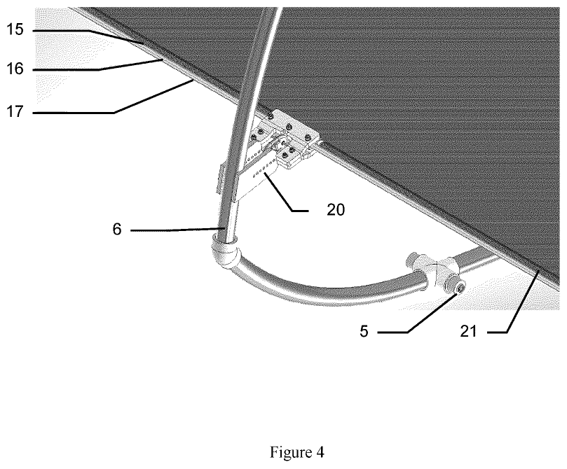

The inclined, flexible duct 2 is fabricated from a plurality of layers of flexible membranes, which are shown in details in FIGS. 3 and 4.

The inclined, flexible, multilayered duct 2 is suspended on a carcass that comprises a plurality of tensioned cables 5 via a plurality of rigid ribs 6, although in a different embodiment said duct 2 can be suspended on the plurality of tensioned cables 5 via a plurality of various types of connectors that connect the grommets on the lengthwise sides of said duct 2 directly to the plurality of tensioned cables 5.

In this embodiment of the system for electricity generation by capturing the energy of raising solar-heated air 1, the cables of the plurality of tensioned cables 5 are parallel to each other along the length of the inclined, flexible, multilayered duct 2.

The plurality of cables 5 are tensioned via auto-tensioners (not shown) between support towers 7 and 8, wherein the support tower 7 supports the inclined, flexible, multilayered duct 2 at the air inlet 3 and the support tower 8 supports said duct 2 at the air outlet 4, thus holding the flexible, multilayered duct 2 inclined in respect to the horizontal plane. Depending on the elevation of the support towers 7 and 8 above the ground level, the angle of inclination a of the inclined, flexible, multilayered duct 2 can vary within any degrees above the 0 degree of the horizontal plane up to and including the 90 degrees of a vertical plane.

The plurality of cables 5 is auto-tensioned by sets of counterweights and/or by any hydraulic and/or electro-mechanic types of auto-tensioners, in order to maintain said cables 5 evenly tensioned irrespectively of the changes of the ambient temperature.

In the example shown in this figure, the support towers 7 and 8 are anchored to the ground by concrete anchors 9 and stabilised by support cables 10 that are also anchored to the ground by concrete anchors 9.

An electricity generation unit 11, which includes an air turbine coupled to an electric generator, is connected to one of the openings 3 or 4 of the inclined, flexible, multilayered duct 2. In the example shown in this figure, the electricity generation unit 11 has a protecting cast and it is mounted via an air converging section 12 to the air outlet 4 of the inclined, flexible, multilayered duct 2.

A weather protector 13, which is made from a material that is capable to withstand damages caused by severe weather conditions, partially covers the inclined, flexible, multilayered duct 2. The weather protector 13 can be positioned anywhere along the length of the inclined, flexible, multilayered duct 2, but in this example it is mounted near the air outlet 4 of said duct 2.

A retracting, protracting and tensioning system 14 comprising winches and brake mechanisms, pulleys, springs and cables allows for retracting, protracting and tensioning the inclined, flexible, multilayered duct 2 in and out of the coverage of the weather protector 13, whenever it is required to provide protection against damages caused by severe weather conditions and to minimise the risk of damages caused by high wind loads.

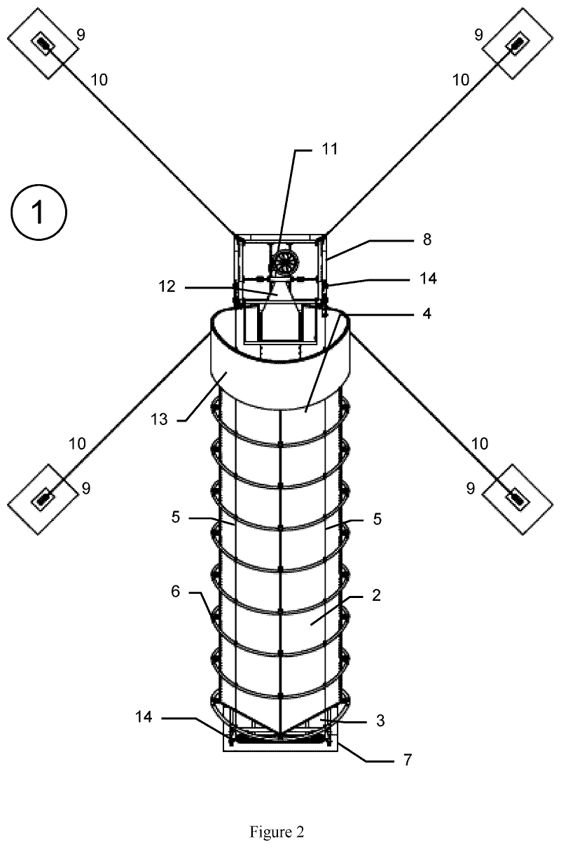

FIG. 2 shows a top view of the system for electricity generation by capturing the energy of raising solar-heated air 1, exhibiting the inclined, flexible, multilayered duct 2 and its air inlet 3 and an air outlet 4, the tensioned cables 5, the rigid ribs 6, the support towers 7 and 8, the concrete anchors 9, the support cables 10, the electricity generation unit 11, the air converging section 12, the weather protector 13, and the retracting, protracting and tensioning system 14.

FIG. 3 shows an example of the cross-section of the inclined, flexible, multilayered duct 2 of the system for electricity generation by capturing the energy of raising solar-heated air 1, exhibiting a rigid rib 6 that is suspended on the plurality of tensioned cables 5.

In this example, the rigid rib 6 support and stretches three flexible membranes that are sealed on top of each other lengthwise, at two of the parallel opposite sides of each flexible membrane. On the top, there is a flexible membrane 15, which is made from an airtight material that is transparent to the solar radiation. In the middle, there is a flexible membrane 16, which is made from a material that is highly absorptive to the solar radiation. At the bottom, there is a flexible membrane 17 that is made from an airtight material.

In this example, the flexible membranes 15 and 17 are wider than the flexible membrane 16, which allows for the formation of a tunnel 18 between the top flexible membrane 15 and the middle flexible membrane 16, and a tunnel 19 between the middle flexible membrane 16 and the bottom flexible membrane 17. The tunnels 18 and 19 are open to the ambient atmosphere only at the air inlet 3 and the air outlet 4 of the inclined, flexible, multilayered duct 2.

In this example, the uprising air flow inside the flexible, multilayered duct 2 is separated by the middle flexible membrane 16 on a top and a bottom air streams. Said streams are moving inside the tunnels 18 and 19, respectively.

In this example, the membranes 15-17 are attached to the rigid ribs 6 via a plurality of connecting and tensioning units 20.

Although it is not shown in this figure, the surface of the flexible membrane 16 may be corrugated and/or made uneven by any other means, and/or have fins of any kind, in order to increase the contact surface between said membrane 16 and the air.

FIG. 4 shows an example of one of the connecting and tensioning units 20, which connects and radially tensions a suspended on the tensioned cables 5 rigid rib 6 to the sealed edges 21 of the flexible membranes 15-17.

The edges of the flexible membranes 15-17 are sealed lengthwise to each other at two of the parallel opposite sides of each flexible membrane, forming an airtight wall of the inclined, flexible, multilayered duct 2. The flexible membranes 15-15 are sealed by means of applying suitable adhesive cement or other adhesives to their sealing surfaces, or by thermal welding, zipping, or by applying other suitable types of mechanical fasteners, for example, pluralities of rivets or stiches or by a combination of rivets and stiches, or by means of using other combinations of chemical, thermal or mechanical fasteners.

In this example, the connecting and tensioning unit 20 is attached to the membranes 15-17 via a plurality of grommets inserted into the sealed edge 21. The tension applied to the membranes 15-17 is regulated by suitably adjusting the length of the connecting and tensioning unit 20.

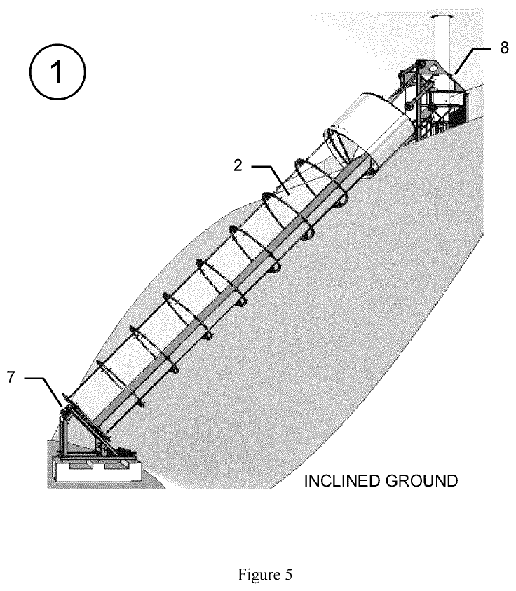

FIG. 5 shows an arrangement of the system for electricity generation by capturing the energy of raising solar-heated air 1, in which the support tower 8 is built above the support tower 7 on an inclined ground. The support towers 7 and 8 are sufficiently high so that the suspended in the air inclined, flexible, multilayered duct 2 does not touch the ground at any point.

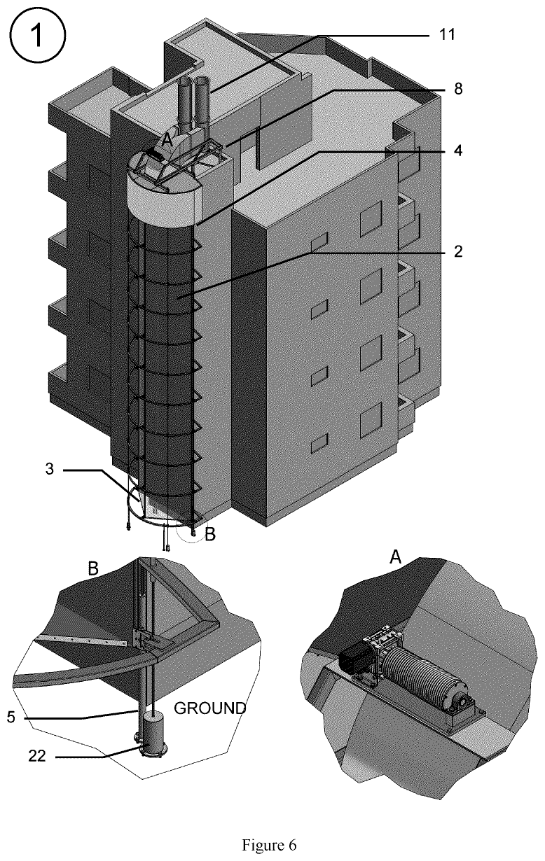

FIG. 6 shows another arrangement of the system for electricity generation by capturing the energy of raising solar-heated air 1, in which the support tower 8 is attached to a vertical wall of a building and the flexible, multilayered duct 2 is stretched along said wall. Similarly to all other examples, the air outlet 4 is located above the air inlet 3 of the flexible, multilayered duct 2.

Notably, the flexible, multilayered duct 2 can be connected to more than one electricity generation units 11. In this example, said duct 2 is connected to two electricity generation units 11.

Magnification A shows a winch and brake mechanism used to contract the flexible, multilayered duct 2 inside the weather protector 13, wherein the protraction of said duct 2 occurs under its own weight when the brake of the winch is released.

Magnification B shows the air inlet 3 of the flexible, multilayered duct 2 and a tensioned cable 5 anchored to the ground. In this example, the plurality of cables 5 are tensioned by the weight of a ballast 22, although in a different arrangement the plurality of cables 5 can be tensioned by spring connectors attached to the ends of said cables 5 and anchored to the ground.

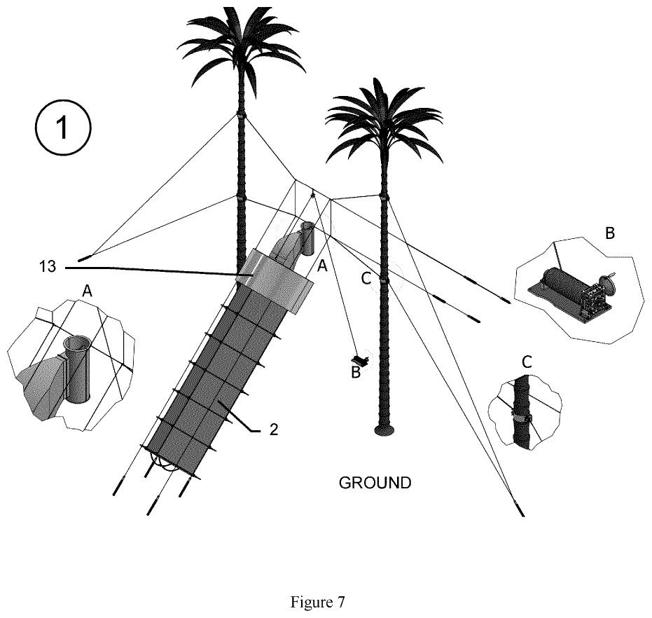

FIG. 7 shows yet another arrangement of the system for electricity generation by capturing the energy of raising solar-heated air 1, in which said system 1 is supported and inclined above the ground by pluralities of cables, pulleys and connectors that are anchored to the ground at the bottom end and that are attached to free standing objects at the top end of said system 1. In this example, said free standing objects are trees.

Magnification A shows an example of an arrangement of the cables and pulleys near the top end of the system for electricity generation by capturing the energy of raising solar-heated air 1.

Magnification B shows a winch and brake mechanism used to contract the flexible, multilayered duct 2 inside the weather protector 13, wherein the protraction of said duct 2 occurs under its own weight when the brake of the winch is released.

Magnification C shows a connector between a cable and a tree's trunk.

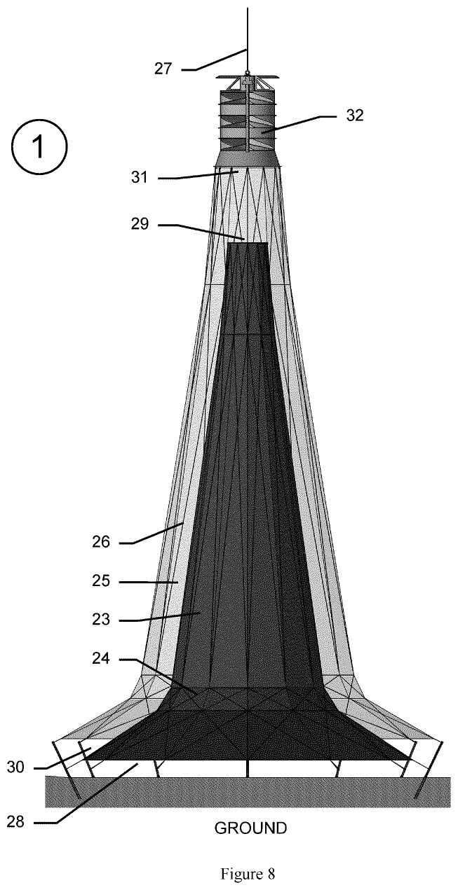

FIG. 8 shows a side view of an alternative embodiment of the system for electricity generation by capturing the energy of raising solar-heated air 1, in which an inner flexible duct 23 is supported and radially stretched by an upstanding inner carcass 24 and an outer flexible duct 25 is supported and radially stretched by an upstanding outer carcass 26. Carcasses 24 and 26 comprise meshes of tensioned flexible cables. The top end 27 of said cables is suspended in the air on one or more free standing objects, varieties of which are shown in the next figures. The bottom ends of the flexible cables are anchored to the ground. The ground that may be of any nature and profile, but in this particular example is a flat, horizontal ground.

The inner flexible duct 23 is a flexible membrane, which is made from a material that is highly absorptive to the solar radiation. The outer flexible duct 25 is a flexible membrane, which is made from an airtight material that is transparent to the solar radiation.

The inner flexible duct 23 has oppening to the ambient atmosphere only at its opposite ends through an air inlet 28 and an air outlet 29, wherein the air outlet 29 is located above the air inlet 28. The outer flexible duct 25 has oppenings to the ambient atmosphere only at its opposite ends through an air inlet 30 and an air outlet 31, wherein the air outlet 31 is located above the air inlet 30.

The air inlets 28 and 30 are elevated above the ground to allow for a free passage of the atmospheric air into the flexible ducts 23 and 25.

The diameter of the inner flexible duct 23 is smaller than the diameter of the outer flexible duct 25, which allows forming an inner and an outer uprising air streams. Said streams are separated by the inner flexible duct 23.

In this example, the diameters of the flexible ducts 23 and 25 decrease along the axis that passes through the planes of the air inlets 28, 30 and the air outlets 29, 31.

Although it is not shown in this figure, the surface of the inner flexible duct 23 may be corrugated and/or made uneven by any other means, and/or have fins of any kind, in order to increase the contact surface between said inner flexible duct 23 and the air.

In this example, an electricity generation unit 32, which includes an air turbine coupled to an electric generator in a protecting cast, is mounted above the air outlet 31 of the outer flexible duct 25.

The weather protection in this embodiment of the system for electricity generation by capturing the energy of raising solar-heated air 1 occurs by simply scrolling the flexible ducts 23, 25 down to the ground and covering said flexible ducts 23, 25 with an appropriate protective coat, whenever it is required to provide protection against damages caused by severe weather conditions and to minimise the risk of damages caused by high wind loads.

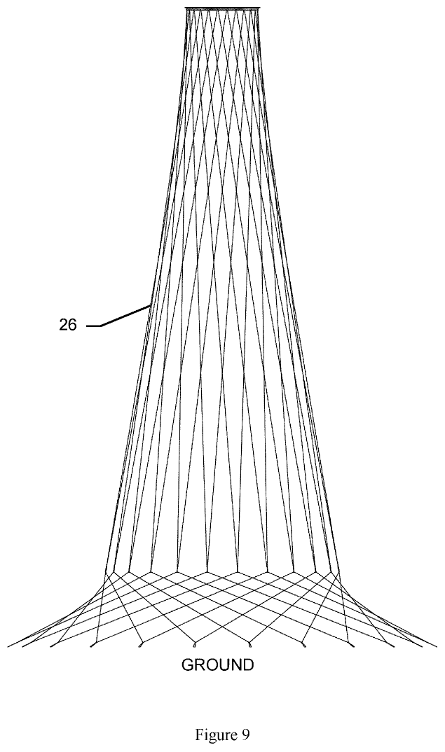

FIG. 9 shows a side view of an example of the mesh arrangement of the cables comprising the upstanding outer flexible carcass 26. The upstanding inner flexible carcass 23 has a similar mesh arrangement of said cables.

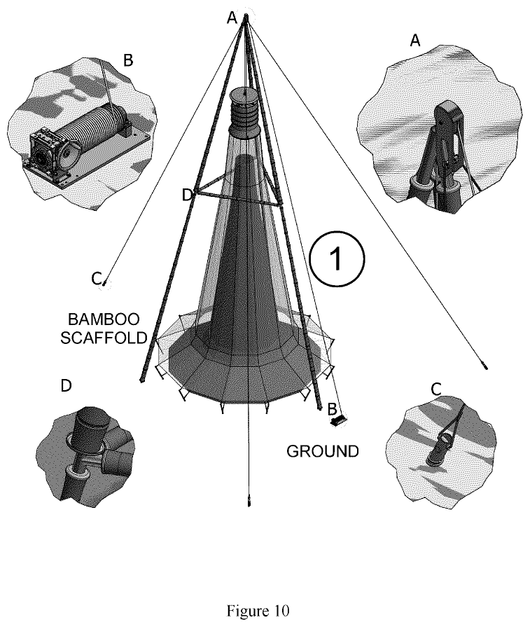

FIG. 10 shows an example of the alternative embodiment of the system for electricity generation by capturing the energy of raising solar-heated air 1, in which said system 1 is suspended in the air by a bamboo scaffold.

Magnification A shows a part of a winch, brake, pulleys and cables mechanism that is used to erect and scroll down the system for electricity generation by capturing the energy of raising solar-heated air 1, and more specifically, an example of a pulley mechanism on top of the bamboo scaffold on which said system 1 is suspended.

Magnification B shows an example of the winch and the brake mechanism that is used to erect and scroll down the system for electricity generation by capturing the energy of raising solar-heated air 1.

Magnification C shows an example of a cable used to support the bamboo scaffold that is anchored to the ground.

Magnification D shows an example of a connector between the parts of the bamboo scaffold.

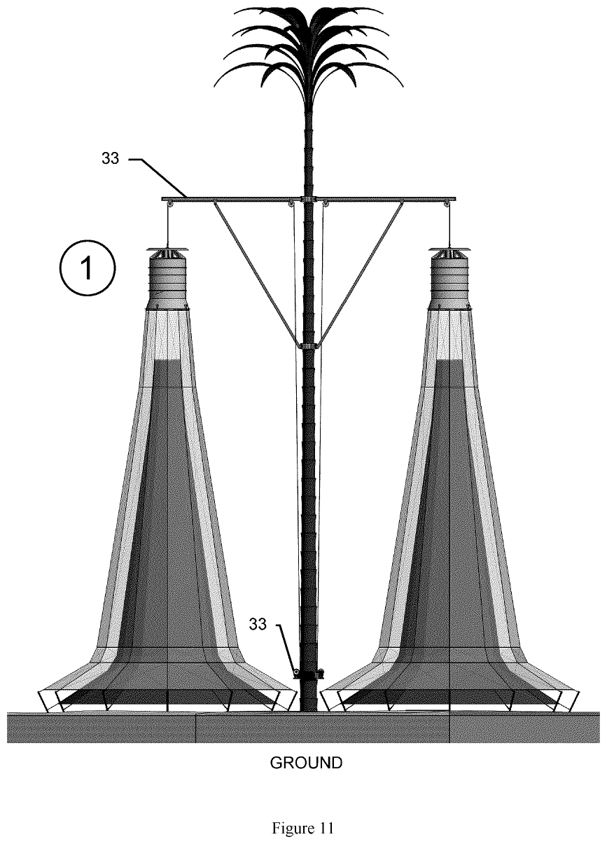

FIG. 11 shows an example of the alternative embodiment of the system for electricity generation by capturing the energy of raising solar-heated air 1, in which two of units of said system 1 are suspended in the air on a single tree. A winch, brake, pulleys, levers and cables mechanism 33 is used to erect, support and scroll down said system 1.

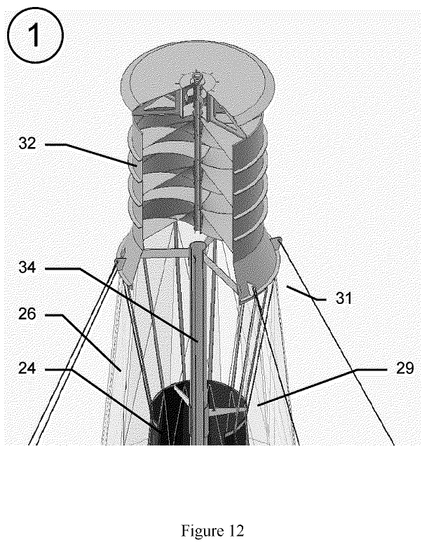

FIG. 12 shows a cross-section near the air outlets 29 and 31 of the alternative embodiment of the system for electricity generation by capturing the energy of raising solar-heated air 1. In this example, a single pole 34 is inserted inside the carcasses 24, 26 and supports said carcasses 24, 26 and the electricity generation unit 32.

In use, the inclined, flexible, multilayered duct 2 or the erected flexible ducts 23, 25 of both alternative embodiments of the system for electricity generation by capturing the energy of raising solar-heated air 1 are exposed to the solar radiation.

In both alternative embodiments of said system 1, the flexible membranes that are made from the material that is highly absorptive to the solar radiation 16 and 23 absorb radiative energy from the sun at the surface that is exposed to the sun. This increases the temperature of the flexible membranes 16 and 23 above the temperature of the ambient atmospheric air, including increasing the temperature at the surface of said membranes 16 and 23 that are not exposed to the sun. The heat released from both surfaces of the flexible membranes 16 and 23 increases the temperature of the air near said membranes 16 and 23 above the temperature of the ambient atmospheric air, which lowers the density of this air compared to the cooler ambient atmospheric air. The acting buoyancy force causes an upward motion of the air that is confined by the flexible membranes 15, 17 or the flexible duct 25 towards the air turbines of the electricity generation unit 11 or 32, where the air flow rotates the turbines of said electricity generation unit 11 or 32 and converts parts of its energy to electricity. The streams of hotter and lighter air inside the inclined, flexible, multilayered duct 2 or the erected flexible ducts 23, 25 are continuously fed by the cooler and denser ambient atmospheric air through the air inlets 3 or 28, 30.

The designs of the units and the methods for supporting the systems for electricity generation by capturing the energy of raising solar-heated air in suspended above the ground, inclined, multi-layered, flexible ducts and in flexible ducts that are supported by upstanding flexible carcasses 1, are not limited to these shown in the FIGS. 1-12. The design of the units and the methods for supporting said systems 1 can be alternated and modified with a purpose of optimisation the performance of said systems 1 in each particular case of their usage. Alternative designs of said units and methods can be implemented for achieving the above purpose whenever practical needs arise.

In one example, the energy of the air flow inside the inclined, flexible, multilayered duct 2 or the erected flexible ducts 23, 25 is converted to electricity in a plurality electricity generation units 11 or 32.

In another example, the energy of the air flow heated in a plurality of inclined, flexible, multilayered ducts 2 and/or in a plurality of the erected flexible ducts 23, 25 is converted to electricity in a single electricity generation unit 11 or 32.

In yet another example, the air inlets 3 of the inclined, flexible, multilayered duct 2 or the air inlets 28 and 30 of the erected flexible ducts 23, 25 are connected to alternative sources of heat, as for example, to sources of waste heat, which heat supplements the energy of the raising solar-heated air and allows for the recuperation of the energy of the air heated by said alternative heat sources in the electricity generation unit 11 or 32.

In yet another example, the energy losses of said electricity generation system 1 are minimised by reflecting thermal radiation coming from the hot parts of said system 1 back to its inner flexible membranes 16 or 23. In particular, the energy losses of the inclined, flexible, multilayered duct 2 are minimised by making the flexible membrane 17 at least partially reflective to the thermal radiation coming from the hot parts of said duct 2, in order to reflect this thermal radiation back to the inner flexible membranes 16.

In yet another example, heat is stores during daytime in thermal reservoirs. During night time, the stored heat is released to the inclined, flexible, multilayered duct 2 or to the erected flexible ducts 23, 25 and utilised for generation of electricity in the electricity generation unit 11 or 32.

In yet another example, the energy output of said system 1 is maximised by intensifying the process of heat transfer between the flexible membranes 16 or 23 and the passing air streams by spraying and/or pouring water over said flexible membranes 16 or 23 where the water evaporates and the heat of the vapour supplements the energy of the passing air streams.

In yet another example, a positioning mechanism is used to move and/or rotate the inclined, flexible, multilayered duct 2 in order to maximise the exposure of the flexible membrane 16 to the solar radiation and to increase energy output of said system 1.

### CITATION LIST

### Patent Literature

AU patent 499934B “Apparatus for converting Solar to Electrical Energy”.
AU patent 2017100315 “A multi-layered structural material for conversion of solar radiation to kinetic energy of fluids”.
AU patent 2017101410 “Recuperation of waste heat to co-generate electricity in solar-wind farms”.
CA patent 1023564 “Utilization of Solar Energy”.
IL patent 50721 “System and Apparatus for Converting Solar Heat to Electrical Energy”.
U.S. Pat. No. 4,275,309 “System for converting solar heat to electrical energy”.
U.S. Pat. No. 7,026,723 “Air filtering chimney to clean pollution from a city and generate electric power”.
U.S. Pat. No. 8,823,197B2 “Diagonal solar chimney”.

### Non Patent Literature

Gunther H, In hundert Jahren—Die kunftige Energieversorgung der Welt, Kosmos Gesellschaft für Naturfreunde Geschaftsstelle: Franckh'sche Verlagshandlung, 1931.
Schlaich J., Bergermann R., Schiel W., Weinrebeet G., Design of Commercial Solar Updraft Tower Systems—Utilization of Solar Induced Convective Flows for Power Generation [online]. http://www.sbp.de/de/html/contact/download/The Solar_Updraft.pdf

1. A system for electricity generation by capturing the energy of raising solar-heated air comprising:
at least one flexible duct that has an airtight flexible wall, which wall has at least one part that is made from a flexible material that is transparent to the solar radiation,
an inner flexible membrane that is located inside said flexible duct and that is made from a flexible material that is highly absorptive to the solar radiation,
two openings to the ambient atmospheric air at the ends of said flexible duct, one opening of said flexible duct being elevated above the other,
at least one tunnel within said flexible duct that is opened to the ambient atmospheric air at the openings of said flexible duct,
at least one air turbine that is coupled to at least one electric generator, and that is connected to at least one of the openings of said flexible duct,
wherein said inner flexible membrane absorbs radiative energy from the sun and heats the surrounding air to a temperature that is above the temperature of the ambient atmospheric air, causing the surrounding air to raise and to flow upwardly inside the tunnels of said flexible duct, and causing the air turbine that is coupled to the electric generator to rotate and to convert the energy of the raising air flow to electricity.

2. The system for electricity generation by capturing the energy of raising solar-heated air according to claim 1, wherein said flexible duct and said inner flexible membrane are supported by at least one carcass that is comprised by a plurality of tensioned cables.

3. The system for electricity generation by capturing the energy of raising solar-heated air according to claims 1 and 2, wherein said flexible duct and said inner flexible membrane are suspended in the air above a ground of any nature and profile by at least one carcass that is comprised by a plurality of tensioned cables.

4. The system for electricity generation by capturing the energy of raising solar-heated air according to claims 1 to 3, wherein said flexible duct and said inner flexible membrane are radially stretched by at least one carcass that is comprised by a plurality of tensioned cables.

5. The system for electricity generation by capturing the energy of raising solar-heated air according to any one of the preceding claims, wherein the contact surface between said inner flexible membrane and the air is increased by corrugating and/or making said inner flexible membrane uneven by any other means, and/or by adding fins of any kind.

6. The system for electricity generation by capturing the energy of raising solar-heated air according to any one of the preceding claims, wherein the cables that comprise the carcasses that support said flexible duct and said inner flexible membrane are auto-tensioned by sets of counterweights and/or by any hydraulic and/or electro-mechanic types of auto-tensioners, in order to maintain said cables evenly tensioned irrespectively of the changes of the ambient temperature.

7. The system for electricity generation by capturing the energy of raising solar-heated air according to any one of the preceding claims, wherein a retracting, protracting and tensioning system comprising at least one winch and brake mechanism and pluralities of pulleys, springs. ballasts, connectors, anchors and cables, is used for retracting, protracting and tensioning said flexible duct and said inner flexible membrane in and out of the coverage of a weather protector, whenever it is required to provide protection to said flexible duct and said inner flexible membrane against damages caused by severe weather conditions and to minimise the risk of damages to said flexible duct and said inner flexible membrane caused by high wind loads.

8. The system for electricity generation by capturing the energy of raising solar-heated air according to any one of the preceding claims, wherein the weather protector of said flexible duct and said inner flexible membrane is made from a material that is capable of withstanding severe weather conditions and high wind loads.

9. The system for electricity generation by capturing the energy of raising solar-heated air according to any one of the preceding claims, wherein at least one tunnel inside said flexible duct provides an unobstructed passage of the atmospheric air between the openings of said flexible duct, when said flexible duct and said inner flexible membrane are tensioned by the retracting, protracting and tensioning system.

10. The system for electricity generation by capturing the energy of raising solar-heated air according to any one of the preceding claims, wherein the energy of the raising solar-heated air is supplemented by the energy of raising air that is heated by other sources of heat and the supplemented heat is recuperated to electrical energy.

11. The system for electricity generation by capturing the energy of raising solar-heated air according to any one of the preceding claims, wherein the energy losses of said electricity generation system are minimised by reflecting thermal radiation coming from the hot parts of said electricity generation system back to its inner flexible membranes.

12. The system for electricity generation by capturing the energy of raising solar-heated air according to any one of the preceding claims, wherein the energy output of said electricity generation system is maximised by storing heat in thermal reservoirs during daytime and releasing the heat stored in the thermal reservoirs during night time to be converted to electricity in said electricity generation system.

13. The system for electricity generation by capturing the energy of raising solar-heated air according to any one of the preceding claims, wherein the energy output of said electricity generation system is maximised by intensifying the process of heat transfer between the inner flexible membranes and the passing air streams by spraying and/or pouring water over said inner flexible membranes where the water evaporates and the heat of the vapour supplements the energy of the passing air streams.

14. The system for electricity generation by capturing the energy of raising solar-heated air according to any one of the preceding claims, wherein a positioning mechanism is used to move and/or rotate the flexible duct in order to maximise the exposure of the inner flexible membrane to the solar radiation and to increase energy output of said electricity generation system.
